(19) United States
(12) Patent Application Publication
(10) Pub. No.: US 2008/0205912 A1
(43) Pub. Date: Aug. 28, 2008

(54) IMAGE FORMING APPARATUS AND CONTROL METHOD THEREOF

(75) Inventor: Masaya Arakawa, Hiratsuka-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/678,197

(22) Filed: Feb. 23, 2007

(51) Int. Cl. G03G 15/00

(52) U.S. Cl. 399/16

(57) ABSTRACT

In an image forming apparatus, papers are taken in one by one using an auto document feeder (ADF) provided with a media sensor to determine the type of papers and successively carried to the reading position while the type of the papers are determined and displayed on the control panel. By inputting the type of image forming media corresponding to the type being displayed from the control panel, an image is formed at a desired image quality.

### BACKGROUND OF THE INVENTION

1. Field of the Invention

The present invention relates to an image forming apparatus and a control method thereof for enabling an image at a satisfactory image quality to be formed correspondingly to the type of papers.

2. Description of the Related Art

For an electrophotographic or ink-jet image forming apparatus, an image forming technique has been developed and a type capable of forming an image in full color has been used extensively. Meanwhile, various types of papers (for copying) as a recording material have been developed to enable image formation in a wider range of types. However, in order to obtain a high-quality image correspondingly to papers of various types and in various thicknesses, it is necessary to optimize conditions relating to image formation depending on papers.

For example, in the electrophotographic method, in the fixing process to heat and apply a pressure to toner particles transferred onto a paper so as to be fixed on the paper, a required amount of heat for a paper varies with the thickness. It is therefore necessary to control the temperature at the time of fixing according to the thickness of papers.

More specifically, in a color copying machine that forms an image by superimposing toner particles (material) in four colors on a single transfer material (paper), an amount of toner particles mounted on the transfer material (paper) is far larger than that in a monochrome copying machine. Hence, a difference in thickness of papers gives a considerable influence to the image quality. In a fixing device adopting a typical heating method that fixes toner particles by fusing, an amount of heat absorbed by papers at the time of fixing becomes larger as the transfer material becomes thicker, and an amount of heat supplied for fusing toner particles is reduced accordingly. Hence, poor fixing readily occurs with a color image having a large amount of toner particles because toner particles are not fused sufficiently. In order to prevent such poor fixing, particularly accurate temperature control is required for a color copying machine in comparison with a monochrome copying machine.

Also, in the transfer process to transfer toner particles onto a paper, the volume resistance value varies with the thickness of papers. It is therefore necessary to change a transfer current to drive the transferring charger in response to the thickness of papers.

Under these circumstances, an image forming apparatus furnished with a capability of detecting the thickness of papers has been developed in recent years.

As a method for detecting the thickness of papers, for example, there are a scheme by which an amount of displacement of the roller when carrying papers is measured (for example, JP-A-10-260562), and a method by which conductive electrodes are disposed in a carrying path oppositely to the both surfaces of a passing paper to measure an electrostatic capacity when the paper passes by (JP-A-05-301655).

However, once the user erroneously sets papers of a type different from the one he intended to use, there is no way to correct such an error. In addition, providing a paper type determination sensor for each cassette accommodating papers therein causes the cost to increase.

### BRIEF SUMMARY OF THE INVENTION

It is an object of the present invention to provide an image forming apparatus that forms an image correspondingly to the type of papers.

In an aspect of the present invention, an image forming apparatus that forms an image on a recording medium includes: an auto document feeder (ADF) that takes in the recoding medium set therein and carries the recording medium to a reading position; a media sensor that determines a type of the recording medium set in the ADF; a control unit configured to enable a selection of a determination mode to determine the type of the recording medium; a display panel that displays information about the type of the image forming medium detected using the media sensor; and a control unit configured to control the media sensor to detect the type of the recording medium set in the ADF when the determination mode for the recording medium is selected from the operation unit.

### DESCRIPTION OF THE DRAWINGS

FIG. 1 is a view showing an example of the configuration of an image forming apparatus according to one embodiment of the invention;

FIG. 2 is a block diagram showing the configuration of a major portion in a control system of the image forming apparatus of FIG. 1;

FIG. 3 is an example of a plan view of a control panel of the image forming apparatus of FIG. 1;

FIG. 4 is a side view of an ADF used in the image forming apparatus according to the embodiment of the invention;

FIG. 5 is a layout view showing an example of the layout of sensors inside the ADF of the image forming apparatus according to the embodiment of the invention;

FIG. 6 is a flowchart showing one embodiment of operations by the user on the image forming apparatus according to the embodiment of the invention and corresponding operations of the image forming apparatus; and

FIG. 7 is a flowchart in an application of the flowchart of FIG. 6 showing one embodiment of the operations of the image forming apparatus.

### DETAILED DESCRIPTION OF THE INVENTION

Throughout this description, the embodiments and examples shown should be considered as exemplars, rather than limitations on the apparatus and methods of the present invention.

Hereinafter, one embodiment of an image forming apparatus of the invention will be described in detail with reference to the drawings.

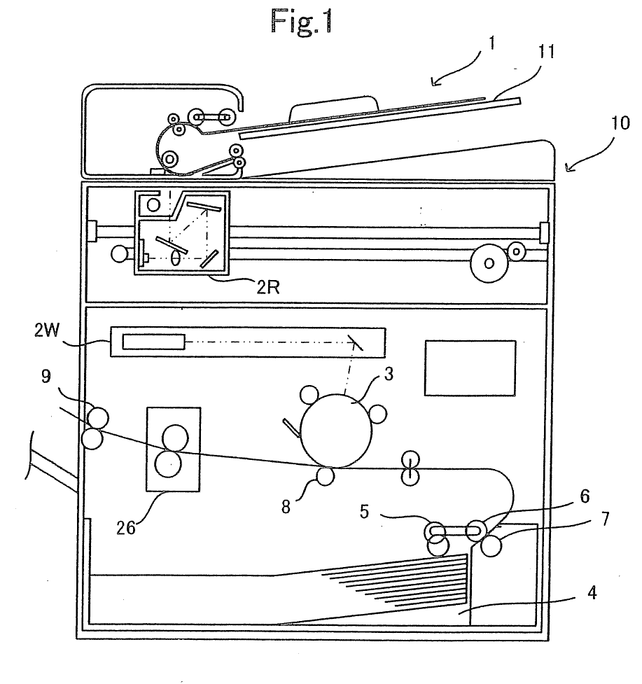

FIG. 1 is a view showing the configuration of one embodiment of an image forming apparatus. An image forming apparatus 10 has an auto document feeder (hereinafter, abbreviated to ADF) 1 that automatically feeds original documents placed by the user, an image reading device (hereinafter, referred to as the scanner unit) 2R that is mounted on a document table 11 of the ADF 1 and performs image reading for the original documents fed from the document table 11, and a photoconductive drum 3 onto which a laser beam is irradiated according to a recording signal after image processing is applied to the image read by the image reading device 2R. A latent image is formed by irradiating a laser beam using an image writing laser scanner 2W onto the photoconductive drum 3.

Also, the image forming apparatus 10 has a cassette 4 to accommodate sheets of paper or film as recording media, a pick-up roller 5 to carry papers to the photoconductive drums 3, a carrying roller 6, and a separation roller 7. Herein, papers accommodated in the cassette 4 are picked up by the pick-up roller 5 according to a recording signal and supplied one by one to the position to oppose the photoconductive drum 3 by the carrying roller 6 and the separation roller 7. Although it is not shown in the drawings, it is possible to supply papers manually by the user.

Further, the image forming apparatus 10 has a transfer device 8 that transfers atoner image formed using toner particles supplied from an unillustrated toner supply device onto papers, a fixing device 26 that fixes the toner images transferred onto the papers, a discharge roller 9 that is provided downstream from the fixing device 26 and discharges the papers on which the toner images have been fixed to a discharge tray provided on the outside of the image forming apparatus 10, and so forth.

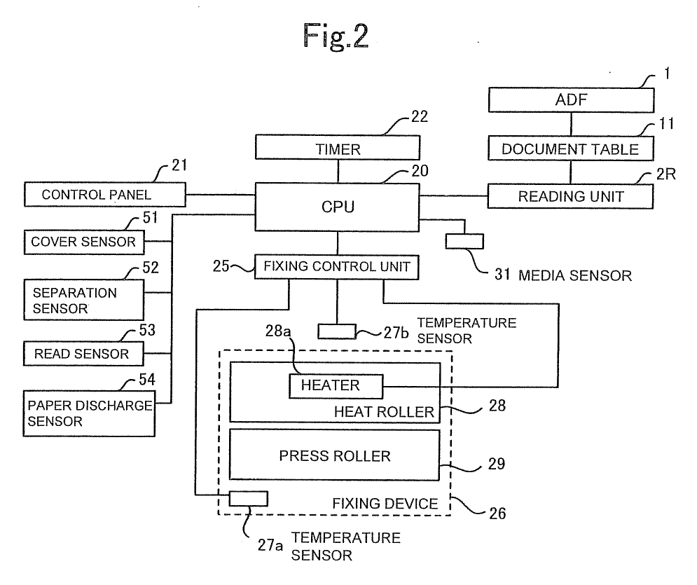

FIG. 2 is a block diagram showing the configuration of a major portion in a control system of the image forming apparatus 10.

The control system of the image forming apparatus 10 has a CPU (Central Processing Unit) 20, a control panel 21, a timer 22, the ADF 1, the reading unit 2R, a fixing control unit 25, and a fixing device 26. Further, the fixing device 26 has temperature sensors 27a and 27b, a heat roller 28 having an internal heater 28a, and a press roller 29.

The CPU 20 controls operations of the entire image forming apparatus 10, and is connected to the control panel 21, the timer 22, the reading unit 2R, and the fixing control unit 25. Herein, the CPU 20 and the fixing control unit 25 together form a control unit that controls all the operations.

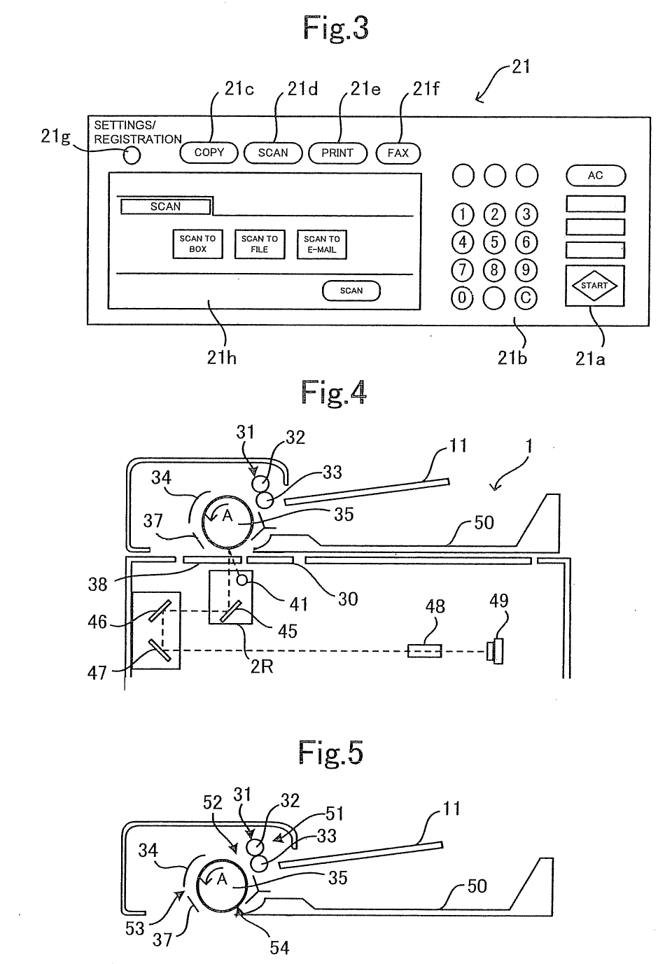

As is shown in FIG. 3 that is an example of a plan view of the control panel 21, the control panel 21 is provided at the level almost as high as the document table 11 (shown in FIG. 1) as an operation unit for setting or selecting image forming conditions. The control panel 21 is used by the user for operations on the image forming apparatus 10, and various settings relating to a copy operation and switching ON of a print key 21e, and so forth are performed. More specifically, the control panel 21 includes a start key 21a, a numerical keypad 21b, a copy key 21c, a scan key 21d, a print key 21e, a facsimile key 21f, a settings and registration key 21g, a liquid crystal display screen 21h, and so forth, and functions as an input unit for an instruction from the user. Further, the user is able to set a determination mode to determine the type of papers via the control panel 21.

The timer 22 measures a time necessary for the control operation in this embodiment.

As is shown in the side view of FIG. 4, the ADF 1 is a device that automatically feeds and discharges original documents, and feeds the original documents one by one to the image reading device 2R to successively read plural original documents. Also, in the inside thereof, a media sensor 31 to determine the type of papers is attached together with various sensors described below.

The media sensor 31 is, for example, to measure the paper thickness of papers as recording media. When a laser beam is irradiated onto papers, a speckle pattern, which is generated by surface scattering, is generated on the papers. By measuring this speckle pattern using a sensor, such as a CCD, it is possible to determine the type of papers from a unique pattern resulting from a roughness of the papers.

Generally, papers are available in the market, and in terms of types, they are roughly divided to plain papers and thick papers. The thick papers can be further divided to four or five types.

The determination of the type of papers by the media sensor 31 is not limited to analysis of the speckle pattern, and detection is possible from an amount of displacement of the roller in the carrying path of the paper feeding unit. Also, a pair of electrodes may be disposed in the carrying path of the paper feeding unit to nip a fed paper so as to detect a change of the electrostatic capacity between the electrodes.

Plural original documents placed on the document table 11 of the ADF 1 are carried one by one. Plural original documents are separated and carried one by one by separation rollers 32 and 33 and carried along carrying guides 34 and 37 in association with rotations of a carrying roller 35 in the direction indicated by an arrow A.

By the time the original documents are carried to the reading position, the reading unit 2R moves directly below a shading correction plate 30 to perform a shading correction. When the shading correction ends, the reading unit 2R moves directly above a skimming window 38 and is in a read-ready state until the original documents are carried thereto.

When the original documents are carried thereto, the surface images on the original documents are read directly below the carrying roller 35. More specifically, a line image of the images of the original documents irradiated by a lamp 41 inside the image reading device 2R is formed on a CCD 49 via a first mirror 45, a second mirror 46, a third mirror 47, and a lens 48, and the line image is read. The transfer roller 35 carries the original documents at a specific rate, and the original documents are read as the original documents are read successively in the sub-scanning direction.

Because the transfer roller 35 carries the original documents at the specific rate, reading of one surface of the original document is performed as the original documents are read successively in the sub-scanning direction. When the reading ends, the original documents are discharged successively to a paper discharge tray unit 39 along a guide 36.

In this embodiment, besides the normal original document reading capability, the ADF 1 is used for determination of the type of papers. More specifically, when the determination mode to determine the type of papers is set using the control panel 21, the user is able to set papers he wishes to be determined in the ADF. Once the papers are set, the papers are taken in the ADF 1 and the type of papers is determined by the media sensor 31.

FIG. 5 is a layout view showing an example of the layout of sensors inside the ADF 1. Like members are labeled with like reference numerals with respect to FIG. 4. Referring to FIG. 5, a cover sensor 51 normally detects that a cover 50 is closed, and in the case of jamming processing, it detects an open state of the cover 50 because the cover 50 is opened.

A separation sensor 52 detects whether plural original documents placed on the document table 11 are at the reading position for the original documents to be separated and fed by the separation rollers 32 and 33. The media sensor 31 detects the type on the basis that the paper thickness of the original documents or papers varies from type to type. By using the media sensor 31, it is also possible to determine an event that original documents or papers are not separated and fed in an overlapped state.

A read sensor 53 detects the absence or presence of original documents in the process of the reading operation by the ADF 1. A paper discharge sensor 54 not only detects that original documents to be discharged by rotating the carrying roller 35 by a specific amount have reached the paper discharge position, but also detects that the original documents to be discharged by carrying the carrying roller 35 by a specific amount are completely discharged and absent at the paper discharge position.

Unillustrated driving motors that drive these sensors 31 and 51 through 54 and the carrying roller 35 are placed under the uniform management by the CPU 20 (shown in FIG. 2).

Returning to the description of FIG. 2, the document table 11 is to place thereon original documents. The reading unit 2R reads images of original documents the user set in the ADF 1 or placed on the document table 11, and gives a notice to the CPU 20 when it detects the presence of original documents.

The fixing control unit 25 performs control relating to the settings of the fixing device 26 as to the fixing temperature and fixing power to be supplied.

In the fixing device 26, the temperature sensor 27b is disposed in close proximity to the heat roller 28 heated by the heater 28a so as to detect the temperature thereof and gives a notice to the fixing control unit 25.

The temperature sensor 27a is disposed in close proximity to the press roller 29 so as to detect the temperature thereof and gives a notice to the fixing control unit 25.

It is possible to provide the media sensor 31 that determines the type of papers to each cassette that accommodates papers therein, which, however, causes the cost to increase. In this embodiment, by providing the media sensor 31 to the ADF 1 that takes in original documents or papers, it is possible to make the cost lower.

Operations by the user on the image forming apparatus 10 of this embodiment configured as described above, and the corresponding operations of the image forming apparatus 10 will be described below.

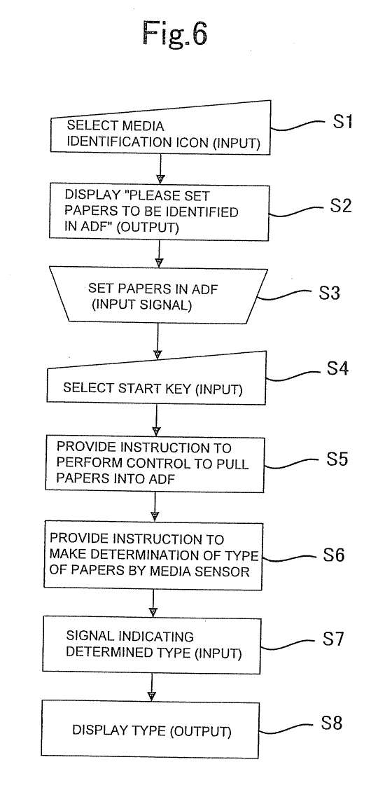

FIG. 6 is a flowchart of the operations by the user on the image forming apparatus 10 of this embodiment and the corresponding operations of the image forming apparatus 10.

Initially, the user selects a media identification icon (not shown) using the settings and registration key 21g by operating the control panel 21 (Step S1).

Consequently, an output signal is outputted to the control panel 21, and “Please set papers to be identified in ADF 1” is displayed (Step S2).

The user sees the display and sets papers he wishes to be identified in the ADF 1 (Step S3). When the papers are set, a signal informing the completion of the setting is inputted into the control unit.

Subsequently, the user depresses a “start key” on the control panel 21 (Step S4). The depression signal is taken into the control unit.

Upon depression of the “start key”, the ADF 1 starts to operate and an instruction is provided for the control to pull the papers into the ADF 1 (Step S5).

The thickness of the papers pulled into the ADF 1 is detected by the media sensor 31 attached to the ADF 1, and an instruction is provided to make a determination of the paper type of the original documents corresponding to the thickness (Step S6).

A signal indicating the paper type of the original documents detected and determined by the media sensor 31 is then inputted into the control unit (Step S7).

The control unit outputs a signal indicating the type to the control panel 21, and the type is displayed on the control panel 21 (Step S7).

The user is thus able to visually confirm the paper type of the original documents from the display.

An application of the embodiment of the operations by the user on the image forming apparatus 10 and the corresponding operations of the image forming apparatus 10 shown in FIG. 6 will now be described.

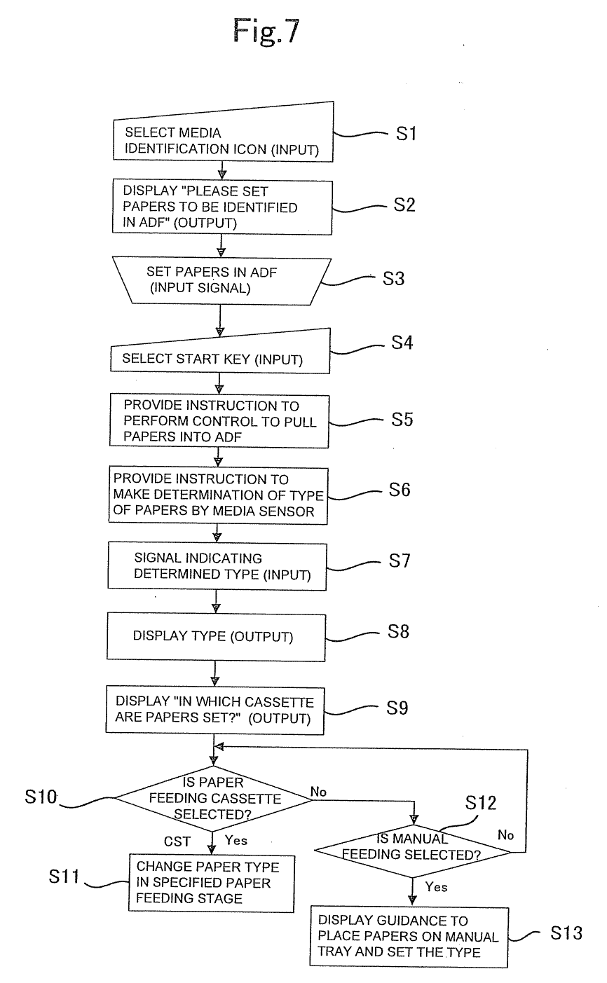

FIG. 7 is a flowchart of an application of the embodiment of the operations by the user on the image forming apparatus 10 and the corresponding operations of the image forming apparatus 10 shown in FIG. 6. Referring to FIG. 7, because Step S1 through Step S8 are the same steps of FIG. 6, descriptions Step Si through Step S8 are omitted herein on the basis of the descriptions with reference to FIG. 6.

More specifically, this is a case where the paper type of the original documents detected and determined by the media sensor 31 is displayed on the control panel 21 in Step S8.

A message, “in which cassette are papers set?”, is displayed on the control panel 21 (Step S9).

Subsequently, whether a paper feeding cassette is selected is determined (Step S10).

When the user selects paper feeding from the cassette 4, the paper feeding stage of the cassette 4 is specified on the control panel 21, and in a case where the paper type of papers in this paper feeding stage is different from the paper type displayed in Step S7, the paper type in the specified paper feeding stage is changed so as to match with the paper type displayed in Step S7 (Step S11).

In a case where the paper feeding cassette is not selected, whether manual feeding is selected is determined (Step S12).

In a case where the user selects manual paper feeding, a guidance, “please place papers on “manual tray” and set the type”, is displayed on the control panel 21 (Step S13). In the case of manual feeding, the processing in Step S13 may be omitted. In a case where the manual feeding is not selected, either, the flow returns to Step S10.

By setting copy papers according to the displays, the user is able to set specific papers without making an error. It is thus possible to perform image formation at a desired image quality in the image forming apparatus 10.

As has been described, according to the embodiment above, because it is possible to notify the user of information about the determination of the type of papers performed in the image forming apparatus, the user is able to perform image formation under the image forming conditions that best suit the papers without any doubt. In other words, because it is possible to select a case where the user needs information about the type of papers, a case where the user needs to confirm the type of papers, and a case where the user does not need the type of papers, the apparatus is user-friendly. Further, because image formation can take place under the conditions suitable for the papers that have been set, it is possible to avoid waste of papers.

Although exemplary embodiments of the present invention have been shown and described, it will be apparent to those having ordinary skill in the art that a number of changes, modifications, or alterations to the invention as described herein may be made, none of which depart from the sprit of the present invention. All such changes, modifications, and alterations, should therefore be seen as within the scope of the present invention.

What is claimed is:

1. An image forming apparatus that forms an image on a recording medium, comprising:
an auto document feeder (ADF) that takes in the recoding medium set therein and carries the recording medium to a reading position;
a media sensor that determines a type of the recording medium set in the ADF;
a control unit configured to enable a selection of a determination mode to determine the type of the recording medium;
a display panel that displays information about the type of the image forming medium detected using the media sensor; and
a control unit configured to control the media sensor to detect the type of the recording medium set in the ADF when the determination mode for the recording medium is selected from the operation unit.

2. An image forming apparatus that forms an image on a recording medium, comprising:
an auto document feeder (ADF) that takes in the recoding medium set therein and carries the recording medium to a reading position;
a media sensor that determines a type of the recording medium set in the ADF;
a control unit configured to enable a selection of a determination mode to determine the type of the recording medium;
a display panel that displays information about the type of the image forming medium detected using the media sensor; and
a control unit configured to control the media sensor to detect the type of the recording medium set in the ADF when the determination mode for the recording medium is selected from the operation unit and to control the display panel to display a detection result.

3. The image forming apparatus according to claim 1 or 2, wherein:
the recording medium is accommodated in a cassette, carried to the ADF from the cassette, and discharged after the type thereof is determined by the media sensor.

4. The image forming apparatus according to claim 1 or 2, wherein:
the recording medium is carried to the ADF by manual paper feeding, and discharged after the type thereof is determined by the media sensor.

5. The image forming apparatus according to claim 1 or 2, wherein:
the control unit changes a fixing condition, a transfer condition, or a carrying condition for image formation in response to the determined type of the recording medium.

6. The image forming apparatus according to claim 2, wherein:
the operation unit allows an input of information about the type of the recording medium the user recognizes in advance; and
the control unit, when there is a difference from the type of the recording medium detected by the media sensor, displays a message indicating the difference on the display panel.

7. The image forming apparatus according to claim 6, wherein:
the media sensor determines the type depending on a thickness of the recording medium.

8. A control method of an image forming apparatus, comprising:
detecting a selection of a determination mode to determine a type of a recording medium;
allowing, when the determination mode is selected, the recording medium to be set in an auto document feeder (ADF) provided with a media sensor;
determining the type of the recording medium using the media sensor provided to the ADF; and
discharging the recording medium from the ADF.

9. A control method of an image forming apparatus, comprising:
detecting a selection of a determination mode to determine a type of a recording medium;
allowing, when the determination mode is selected, the recording medium to be set in an auto document feeder (ADF) provided with a media sensor;
determining the type of the recording medium using the media sensor provided to the ADF;
displaying a result of the determination on a display unit; and
discharging the recording medium from the ADF.

10. The control method of an image forming apparatus according to claim 8 or 9, wherein:
an image forming condition is matched in response to the type of the recording medium obtained from a result of the determination.
